(19) United States
(12) Patent Application Publication
(10) Pub. No.: US 2023/0411811 A1
(43) Pub. Date: Dec. 21, 2023

(54) SECONDARY BATTERY AND DEVICE INCLUDING THE SAME

(71) Applicant: LG ENERGY SOLUTION, LTD., Seoul (KR)

(72) Inventors: Jeong Eon PARK, Daejeon (KR); Do Gyun KIM, Daejeon (KR); Jun Tak KIM, Daejeon (KR); Roun KIM, Daejeon (KR)

(73) Assignee: LG ENERGY SOLUTION, LTD., Seoul (KR)

(21) Appl. No.: 18/035,586

(22) PCT Filed: Nov. 3, 2021
(86) PCT No.: PCT/KR2021/015759

§ 371 Date: May 5, 2023

(30) Foreign Application Priority Data
Nov. 6, 2020 (KR) 10-2020-0147668

(51) Int. Cl. H01M 50/595; H01M 10/04; H01M 4/66; H01M 50/107; H01M 50/152

(52) U.S. Cl. CPC H01M 50/595; H01M 10/0431; H01M 4/661; H01M 50/107; H01M 50/152

(57) ABSTRACT

A secondary battery includes a jelly roll type electrode assembly in which a first electrode, a second electrode, and a separator are wound together; a battery case that houses the electrode assembly; and a swelling tape attached to the outer peripheral surface of the electrode assembly. The first electrode includes a first electrode current collector and a first active material layer formed by applying an electrode active material onto the first electrode current collector. The first electrode current collector includes an exposed portion exposed to the outer peripheral surface of the electrode assembly. The swelling tape brings the exposed portion into close contact with the inner wall of the battery case.

### CROSS CITATION WITH RELATED APPLICATION(S)

This application claims the benefit of Korean Patent Application No. 10-2020-0147668 filed on Nov. 6, 2020 with the Korean Intellectual Property Office, the disclosure of which is incorporated herein by reference in its entirety.

### TECHNICAL FIELD

The present disclosure relates to a secondary battery and a device including same, and more particularly, to a secondary battery including a jelly roll electrode assembly, and a device including same

### BACKGROUND

As the demands for portable electronic products such as notebooks, video cameras and cellular phones are rapidly increased in these days, and development of electric vehicles, energy storage batteries, robots, satellites, etc. is under active progress, numerous studies are being made on secondary batteries being used as the driving power source.

The secondary battery includes, for example, a nickel cadmium battery, a nickel hydrogen battery, a nickel zinc battery, a lithium secondary battery, and the like. Among them, lithium secondary batteries have advantages over nickel-based secondary batteries in that they have less memory effect, can perform charge and discharge freely, have a very lows self-discharge rate, a high operating voltage, and a high energy density per unit weight, and therefore, are widely used in the field of advanced electronic devices.

Based on the shape of a battery case, a secondary battery is classified into a cylindrical battery where an electrode assembly is built into a cylindrical metal can, a prismatic battery where an electrode assembly is mounted in a prismatic metal can, and a pouch-type battery where an electrode assembly is mounted in a pouch type case formed of an aluminum laminate sheet. Among them, the cylindrical battery has an advantage in that it has a relatively large capacity and is structurally stable.

The electrode assembly mounted in the battery case is a power generating element, having a cathode/separator/anode stack structure, which can be charged and discharged, and the electrode assembly is classified into a jelly-roll type, a stacked type and a stacked/folded type. The jelly-roll type electrode assembly is configured to have a structure in which a long sheet type cathode and a long sheet type anode, to which active materials are applied, are wound in a state where a separator is interposed between the cathode and the anode, the stacked type electrode assembly is configured to have a structure in which a large number of cathodes having a predetermined size and a large number of anodes having a predetermined size are sequentially stacked in a state in which separators are interposed between the cathodes and the anodes, and the stacked/folded type electrode assembly is a combination of the jelly-roll type electrode assembly and the stacked type electrode assembly. Among them, the jelly-roll type electrode assembly has advantages in that manufacturing is easy and an energy density per unit weight is high.

FIG. 1 is a perspective view of an electrode assembly in the form of a jelly roll included in a conventional secondary battery.

Referring to FIG. 1, a conventional electrode assembly 20a is formed by winding an anode, a cathode, and a separator 23, wherein the separator 23 may be located at the outermost side of the electrode assembly 20a. In addition, a finishing tape 50 can be attached so as to cover a finishing part 23E of the separator 23. By attaching the finishing tape 50, the shape of the wound electrode assembly 20a can be maintained, and a phenomenon where the electrode assembly 20a is loosened due to internal stress can be prevented.

The electrode assembly 20a may include electrode tabs 21 and 22 protruding in mutually opposite directions. Specifically, the anode tab 21 and the cathode tab 22 respectively connected to the anode and the cathode may be protruded in mutually opposite directions.

On the other hand, in order to enhance the performance of the lithium-ion secondary battery, the resistance must be lowered, wherein the resistance of the secondary battery depends on the resistance possessed by the electrode tabs 21 and 22 or the path through which electrons can move within the secondary battery. The conventional electrode assembly 20a shows a problem that the resistance is high because the electrode assembly 20a is connected to an external terminal or the like via the electrode tabs 21 and 22 having a narrow width.

Therefore, there is a growing necessity for a secondary battery that lowers a resistance, has a long life, and exhibits high efficiency, along with the demand for a high-output secondary battery.

### DETAILED DESCRIPTION OF THE INVENTION

### Technical Problem

It is an object of the present disclosure to provide a secondary battery that can reduce the resistance by providing a path for electrons to move in addition to electrode tabs, and a device including the same.

However, the problem to be solved by the embodiments of the present disclosure is not limited to the above-described problems, and can be variously expanded within the scope of the technical idea included in the present disclosure.

### Technical Solution

According to one embodiment of the present disclosure, there is provided a secondary battery comprising: a jelly roll type electrode assembly having a first electrode, a second electrode, and a separator, wherein the first electrode, the second electrode, and the separator are wound together; a battery case receiving the electrode assembly therein; and a swelling tape attached to an outer peripheral surface of the electrode assembly, wherein the first electrode comprises a first electrode current collector and a first active material layer having an electrode active material on the first electrode current collector, wherein the first electrode current collector comprises an exposed portion exposed to the outer peripheral surface of the electrode assembly, and wherein the swelling tape causes the exposed portion to contact an inner wall of the battery case.

The secondary battery may include an electrolyte solution that is injected inside of the battery case, wherein the swelling tape may be expanded by absorbing the electrolyte solution.

The swelling tape may be asymmetrically attached to the outer peripheral surface of the electrode assembly with respect to a center of the electrode assembly.

The swelling tape may wrap the outer peripheral surface of the electrode assembly by 0.3 times or more of a circumference of the outer peripheral surface and 0.75 times or less of the circumference of the outer peripheral surface.

The swelling tape may extend along a height direction of the electrode assembly.

The swelling tape may cover an outermost edge part of the exposed portion.

The first electrode may be an anode, and the first electrode current collector may include at least one of copper, stainless steel, aluminum, or nickel.

The first electrode may include a first electrode tab extending along a height direction of the electrode assembly, and the first electrode tab may contact the battery case.

The secondary battery may include a cap assembly located at an end of the battery case opposite an end where the first electrode tab contacts the battery case.

The battery case may be a cylindrical case.

### Advantageous Effects

According to the embodiments of the present disclosure, the electrode current collector is exposed to the outer peripheral surface, and the contact between the electrode current collector and the inner wall of the battery case is guided using a swelling tape, thereby being able to secure an electron movement path other than the electrode tab. Therefore, the resistance can be reduced, so that the lifespan and efficiency of the secondary battery can be improved.

Additionally, when the swelling tape is expanded by absorbing an electrolyte solution, the electrode assembly can be fixed inside the battery case, and vibration resistance can be improved.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view of an electrode assembly in the form of a jelly roll included in a conventional secondary battery.

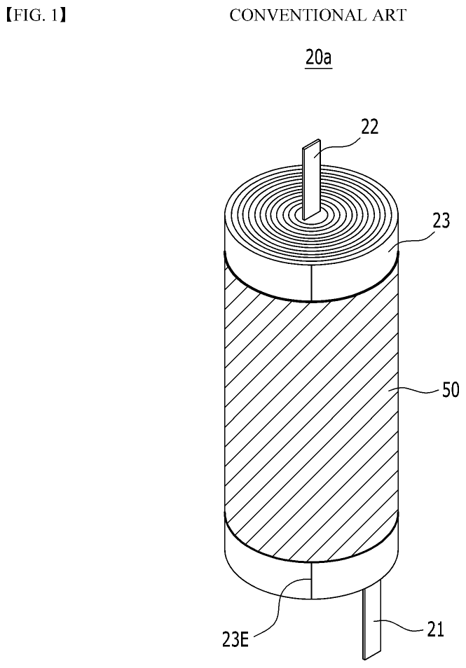

FIG. 2 is a perspective view of a secondary battery according to an embodiment of the pre sent disclosure;

FIG. 3 is an exploded perspective view of the secondary battery of FIG. 2;

FIG. 4 is a perspective view of an electrode assembly included in the secondary battery of FIG. 3;

FIG. 5 is an exploded perspective view showing a state before winding the electrode assembly of FIG. 4;

FIG. 6 is a perspective view showing a state in which a swelling tape according to an embodiment of the present disclosure is attached to the electrode assembly of FIG. 4;

FIG. 7 is a cross-sectional view showing a cross-section taken along the cutting line A-A′ of FIG. 2; and

FIG. 8 is a perspective view of an electrode assembly to which two sealing tapes are attached according to a comparative example of the present disclosure.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed on the upper end of the reference portion toward the opposite direction of gravity.

Further, throughout the description, when a portion is referred to as “including” or “comprising” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

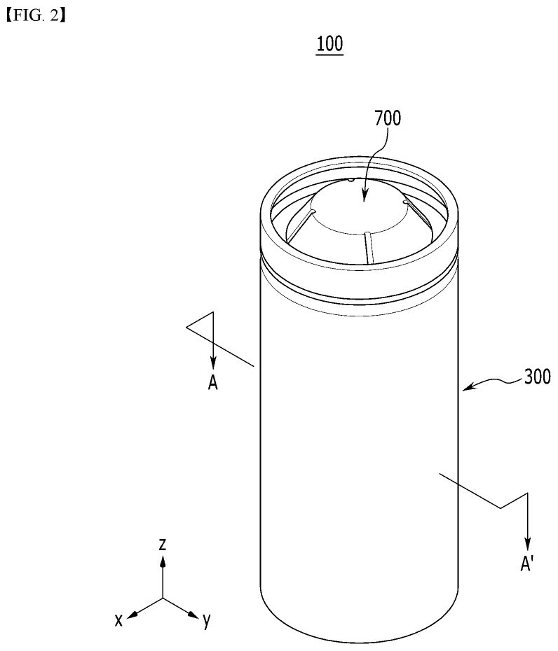

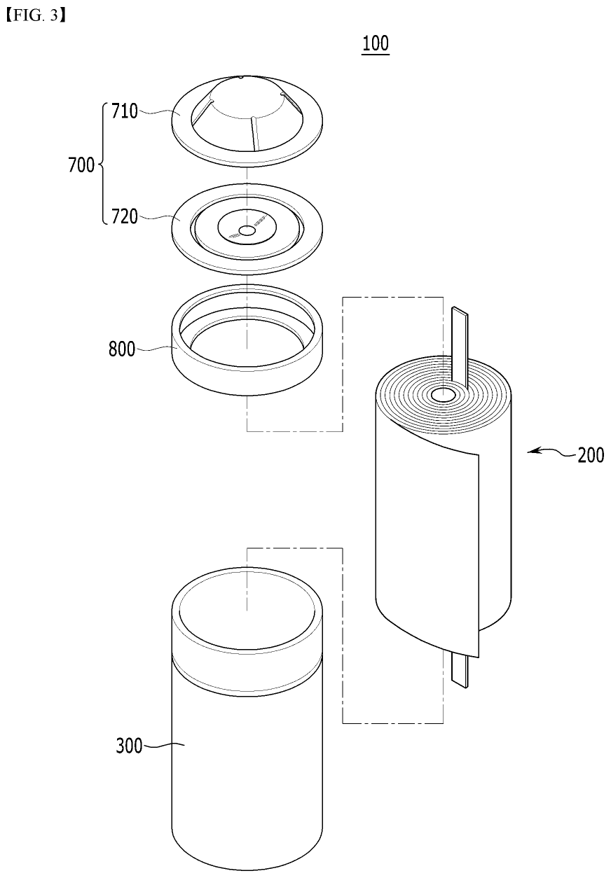

FIG. 2 is a perspective view of a secondary battery according to an embodiment of the present disclosure. FIG. 3 is an exploded perspective view of the secondary battery of FIG. 2.

Referring to FIGS. 2 and 3, a secondary battery 100 according to an embodiment of the present disclosure includes a jelly roll type electrode assembly 200 and a battery case 300 that houses the electrode assembly 200. Specifically, the secondary battery 100 according to the present embodiment can be manufactured by housing the electrode assembly 200 in the battery case 300 having an open upper part, injecting an electrolyte solution into the battery case 300, and then coupling the cap assembly 700 to the open upper part of the battery case 300.

The battery case 300 is a structure that houses the electrode assembly 200 impregnated with the electrolyte solution, which may include a metal material and may be a cylindrical case.

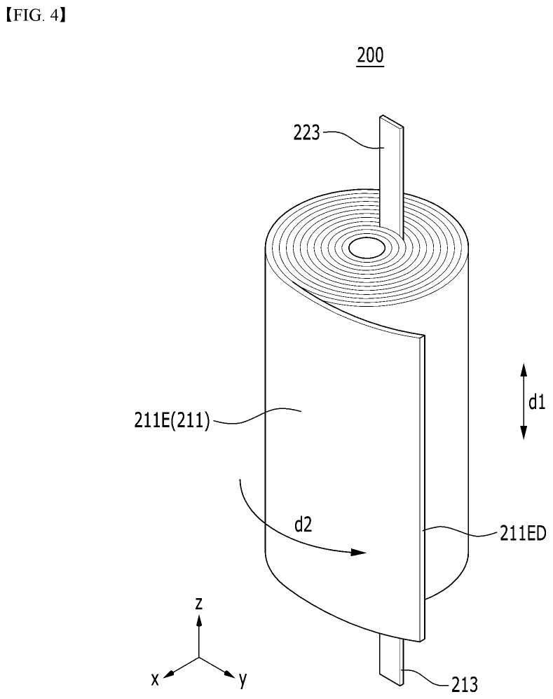

Next, the electrode assembly 200 and the exposed portion 211E according to the present embodiment will be described in detail with reference to FIGS. 4 to 6 and the like.

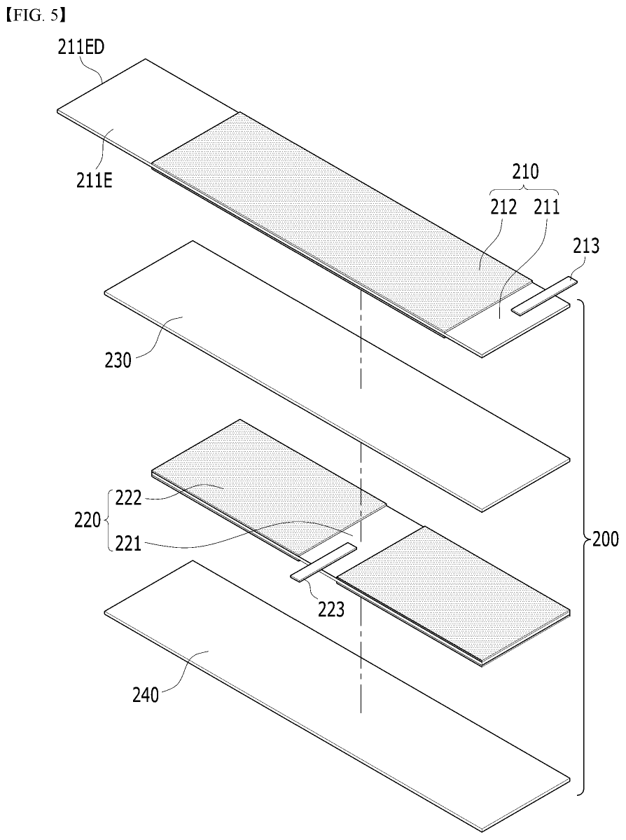

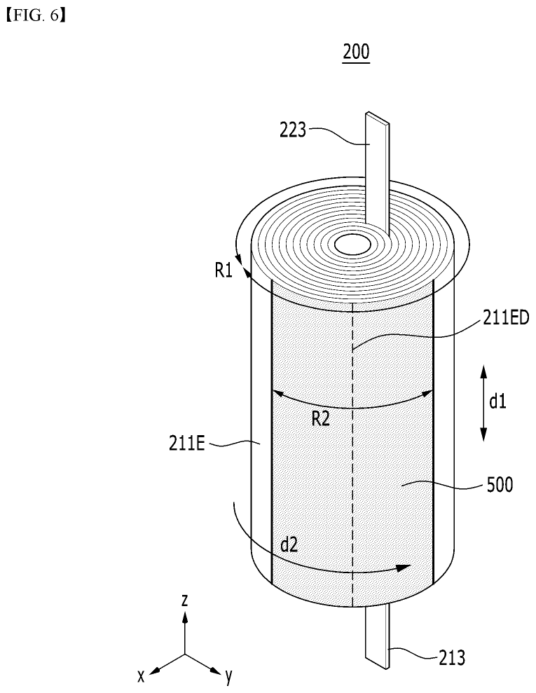

FIG. 4 is a perspective view of an electrode assembly included in the secondary battery of FIG. 3. FIG. 5 is an exploded perspective view showing a state before winding the electrode assembly of FIG. 4. FIG. 6 is a perspective view showing a state in which a swelling tape according to an embodiment of the present disclosure is attached to the electrode assembly of FIG. 4.

First, referring to FIGS. 3 to 5, the electrode assembly 200 according to the present embodiment may include a first electrode 210, a second electrode 220, and a separator 230. The first electrode 210, the second electrode 220, and the separator 230 can be wound together to form the jelly roll type electrode assembly 200. The separator 230 can be interposed between the first electrode 210 and the second electrode 220. Additionally, as shown in FIG. 5, when wound in the form of a jelly roll, in order to prevent the first electrode 210 and the second electrode 220 from coming into contact with each other, it is preferable to further arrange a separator 240 under the second electrode 220.

The first electrode 210 includes a first electrode current collector 211 and a first active material layer 212 formed by applying an electrode active material onto the first electrode current collector 211. Specifically, the electrode active material is applied onto the first electrode current collector 211 to form the first active material layer 212, and to a portion where the electrode active material is not applied among the first electrode current collector 211 and thus the first electrode current collector 211 is exposed, a first electrode tab 213 can be attached by a method such as welding. Here, the first electrode tab 213 is illustrated as being located at one end part of the first electrode 210, but the position is not particularly limited, and it can be located at the center of the first electrode 210.

The second electrode 220 includes a second electrode current collector 221 and a second active material layer 222 formed by applying an electrode active material onto the second electrode current collector 221. Specifically, the electrode active material is applied onto the second electrode current collector 221 to form the second active material layer 222, and to a portion where the electrode active material is not applied among the second electrode current collector 221 and thus the second electrode current collector 221 is exposed, the second electrode tab 223 can be attached by a method such as welding. Here, the second electrode tab 223 is illustrated as being located at the central part of the second electrode 220, but the position is not particularly limited, and it can be located at one end part of the second electrode 220.

Meanwhile, the first electrode current collector 211 includes an exposed portion 211E exposed to the outer peripheral surface of the electrode assembly 200. As shown in FIG. 5, the exposed portion 211E may be located at the other end part of the first electrode 210 spaced apart from the portion to which the first electrode tab 213 is attached. When the electrode assembly 200 of FIG. 5 is wound, the exposed portion 211E is exposed on the outer peripheral surface of the electrode assembly 200 as shown in FIG. 4.

Meanwhile, as shown in FIG. 6, the secondary battery 100 according to the present embodiment includes a swelling tape 500 attached to the outer peripheral surface of the electrode assembly 200. The swelling tape 500 according to the present embodiment may extend along the height direction d1 of the electrode assembly 200 and may cover the outermost edge part 211ED of the exposed portion 211E. For convenience of explanation, the swelling tape is not shown in FIG. 4, but the swelling tape is shown in FIG. 6.

Here, the outer peripheral surface of the electrode assembly 200 refers to a curved surface portion on the outer side of the wound cylindrical electrode assembly 200. The height direction d1 of the electrode assembly 200 refers to a direction in which the electrode tabs 213 and 223 protrude with respect to the electrode assembly 200 (z-axis direction and −z-axis direction). The outermost edge part 211ED of the exposed portion 211E refers to one end part that is wound finally when winding the first electrode 210.

The first electrode current collector 211 is extended to one side to form an exposed portion 211E, and the exposed portion 211E is further wound as much as extended, so that an exposed portion 211E can be formed on at least a part of an outer peripheral surface of the electrode assembly 200.

Next, the electron movement path and the swelling tape 500 formed by the exposed portion 211E according to the present embodiment will be described in detail with reference to FIGS. 3, 6, 7, and the like.

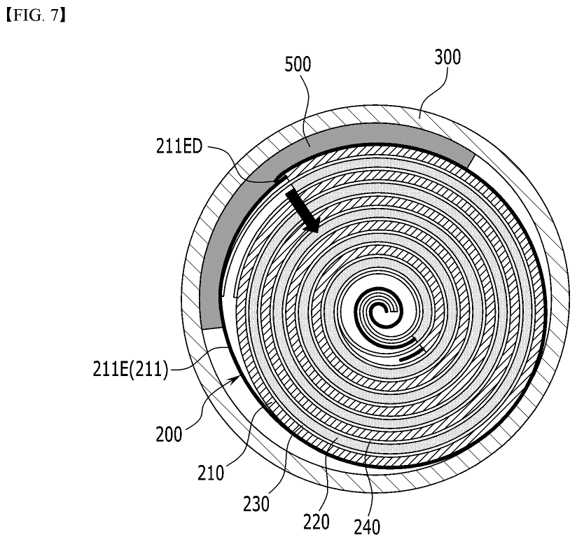

FIG. 7 is a cross-sectional view showing a cross-section taken along the cutting line A-A′ of FIG. 2.

Referring to FIGS. 3, 6 and 7, at least a part of the exposed portion 211E formed on the outer peripheral surface of the electrode assembly 200 come into contact with the inner wall of the battery case 300. The protruded first electrode tab 213 is joined to the bottom of the battery case 300, so that the battery case 300 can function as an electrode terminal for connection to an external circuit. An additional electron movement path other than the first electrode tab 213 can be secured by the contact between the exposed portion 211E and the inner wall of the battery case 300. By securing an additional electron movement path, the resistance of the secondary battery 100 can be reduced, whereby the secondary battery according to the present embodiment can be improved in the lifespan and efficiency.

At this time, the swelling tape 500 according to the present embodiment brings the exposed portion 211E into close contact with the inner wall of the battery case 300. Such a swelling tape 500 extends along the height direction d1 of the electrode assembly 200, so that not only it can maintain the shape of the wound electrode assembly 200, but also it can guide the exposed portion 211E and the inner wall of the battery case 300 to be more easily contacted and connected.

Further, since the swelling tape 500 according to the present embodiment extends along the height direction d1 of the electrode assembly 200 and is in a form of covering outermost edge part 211ED of the exposed portion 211E, it is possible to maintain the shape of the electrode assembly 200 and thus prevent a loosening phenomenon.

Further, the swelling tape 500 can be asymmetrically attached to the outer peripheral surface of the electrode assembly 200 with respect to the center of the electrode assembly 200. In other words, the swelling tape 500 can be attached to only a part of the outer peripheral surface of the electrode assembly 200, rather than wrapping the entire outer peripheral surface. Thereby, the area of the exposed portion 211E facing the inner wall of the battery case 300 can be increased, and securing the contact area between the exposed portion 211E and the inner wall of the battery case 300 can lead to effective resistance reduction.

Furthermore, the swelling tape 500 may wrap the outer peripheral surface of the electrode assembly 200 by 0.3 or more and 0.75 or less. Here, the number of times of winding means a value obtained by dividing the horizontal length of the swelling tape 500 along the winding direction of the electrode assembly by the peripheral length formed by the outer peripheral surface of the electrode assembly. Specifically, the value obtained by dividing the horizontal length R2 of the swelling tape 500 with respect to the winding direction d2 of the electrode assembly 200 by the circumferential length R1 formed by the outer peripheral surface of the electrode assembly 200 may be 0.3 or more and 0.75 or less. If the swelling tape 500 wraps the outer peripheral surface of the electrode assembly 200 by more than 0.75 times, the area in which the exposed portion 211E of the electrode assembly 200 comes into contact with the inner wall of the battery case 300 is reduced, which is not effective in reducing resistance. If the swelling tape 500 wraps the outer peripheral surface of the electrode assembly 200 by less than 0.3 times, the force for fixing the electrode assembly 200 is weak, which may cause a problem that the electrode assembly 200 wound before housing the electrode assembly 200 in the battery case 300 is unwound. Here, the winding direction d2 refers to a direction in which the first electrode 210 or the second electrode 220 is wound in the jelly roll type electrode assembly 200. In FIG. 4, the winding direction d2 corresponds to a counterclockwise direction in a cross-section of the electrode assembly 200 cut in the xy plane.

Further, since the swelling tape 500 extends along the height direction d1, a step difference in the height direction d1 among the outer peripheral surfaces of the electrode assembly 200 is not formed. Therefore, the exposed portion 211E can be brought into contact with the inner wall of the battery case 300 more evenly, whereby the resistance deviation of the electrode assembly 200 can be reduced.

Meanwhile, referring to FIG. 7, as described above, the electrolyte solution is injected into the battery case 300 and impregnated in the electrode assembly 200, and the swelling tape 500 according to the present embodiment may be expanded by absorbing the electrolyte solution. When the swelling tape 500 asymmetrically attached to the outer peripheral surface of the electrode assembly 200 with respect to the center of the electrode assembly 200 is expanded by absorbing the electrolyte solution, the exposed portion 211E of the electrode assembly 200 provided on the opposite side of the swelling tape 500 is brought into close contact with the inner wall of the battery case 300. That is, the contact performance between the exposed portion 211E and the battery case 300 is increased by the expanded swelling tape 500, and a movement path of electrons other than the electrode tab is secured, so that the resistance of the secondary battery can be reduced.

Further, as the charge and discharge of the electrode assembly 200 are repeated, the electrode assembly 200 repeats expansion and contraction, but the electrode assembly 200 is not fixed inside the battery case 300 during contraction, which causes a problem that the vibration resistance is weakened. However, since the swelling tape 500 according to the present embodiment can fix the electrode assembly 200 inside the battery case 300, the vibration resistance can be improved.

Meanwhile, the swelling tape 500 may include a substrate layer and an adhesive layer.

In one embodiment of the present disclosure, the substrate layer may include a urethane bond, ester bond, ether bond, or cellulose ester compound. In addition, as the substrate layer, an acrylate-based substrate layer, a urethane-based substrate layer, an epoxy-based substrate layer, or a cellulose-based substrate layer may be exemplified. In one example, as the acrylate-based, urethane-based or epoxy-based substrate layer, a cast layer of an active energy ray-curable composition can be used. Here, the cast layer may mean a substrate layer formed by coating a curable composition by a casting method and curing the coating layer.

As the adhesive layer, the material is not limited as long as it can form a certain fixing force. In one example, an acrylic adhesive, a urethane adhesive, an epoxy adhesive, a silicone adhesive, a rubber-based adhesive and the like can be used.

When such a substrate layer comes into contact with an electrolyte solution, deformation that stretches in a direction parallel to the outer peripheral surface of the electrode assembly 200 can occur, and the substrate layer is stretched in a state of being fixed by an adhesive layer on the outer peripheral surface of the electrode assembly 200, the swelling tape 500 realizes a three-dimensional shape. Thereby, the swelling tape 500 can be expanded in a direction perpendicular to the outer peripheral surface of the electrode assembly 200.

Other embodiments of the invention can include a substrate layer and an adhesive swelling layer. The substrate layer may be a polymer film. For example, the substrate layer may include polyvinyl chloride, polyethylene terephthalate, polyethylene, polypropylene, polyamide, polycarbonate, polyimide, polystyrene, and the like, and preferably, it may include polystyrene.

Meanwhile, the adhesive swelling layer may include a crosslinked structure of an acrylic polymer. The crosslinked structure may be formed by crosslinking the acrylic polymer with a polyfunctional crosslinking agent. The acrylic polymer may be obtained by radical polymerization of a monomer mixture, and the monomer mixture includes alkyl (meth)acrylate, vinyl acetate and (meth)acrylic acid. For example, the alkyl (meth)acrylate may include methyl (meth)acrylate, ethyl (meth)acrylate, n-propyl (meth)acrylate, isopropyl (meth)acrylate, n-butyl (meth)acrylate, t-butyl (meth)acrylate, sec-butyl (meth)acrylate, pentyl (meth)acrylate, 2-ethylhexyl (meth)acrylate, 2-ethylbutyl (meth)acrylate, n-octyl (meth)acrylate, isooctyl (meth)acrylate, isononyl (meth)acrylate, lauryl (meth)acrylate, tetradecyl (meth)acrylate, and the like, and each of them may be used independently or in combination. Preferably, the alkyl group preferably has 4 or more carbon atoms, and for example, n-butyl (meth)acrylate can be used. The adhesive swelling layer may be expanded as it is immersed in the electrolyte solution.

Meanwhile, referring to FIG. 5 again, the first electrode 210 may be an anode, and the second electrode 220 may be a cathode. That is, the first electrode current collector 211 and the first electrode tab 213 may be an anode current collector and an anode tab, respectively, and the second electrode current collector 221 and the second electrode tab 223 may be a cathode current collector and a cathode tab, respectively. The first electrode current collector 211 is an anode current collector, which may include at least one of copper, stainless steel, aluminum, and nickel, and a negative active material may be applied thereon to form the first active material layer 212. The second electrode current collector 221 is a cathode current collector, which may include at least one of stainless steel, aluminum, nickel, and titanium, and a positive active material may be applied thereon to form a second active material layer 222.

Meanwhile, referring FIG. 3 again, the cap assembly 700 may include an upper end cap 710 and a safety vent 720. The upper end cap 710 may be located on the safety vent 720 and can be electrically connected to each other by forming a structure in close contact with the safety vent 720. The upper end cap 710 has a center that protrudes upward, and is indirectly connected to the second electrode 220 of the electrode assembly 200 via the second electrode tab 223, and can perform a function as an electrode terminal by connecting with an external circuit.

Meanwhile, a gasket 800 for sealing may be located between the battery case 300 and the cap assembly 700. Specifically, the gasket 800 is located between the battery case 300 and the cap assembly 700, and the end part of the battery case 300 is bent, thereby being able to form a crimping part. This makes it possible to attach the cap assembly 700 and seal the secondary battery.

Next, through specific experiments covering Examples and Comparative Examples of the present disclosure, the effect of the resistance reduction according to the embodiments of the present disclosure will be described in detail.

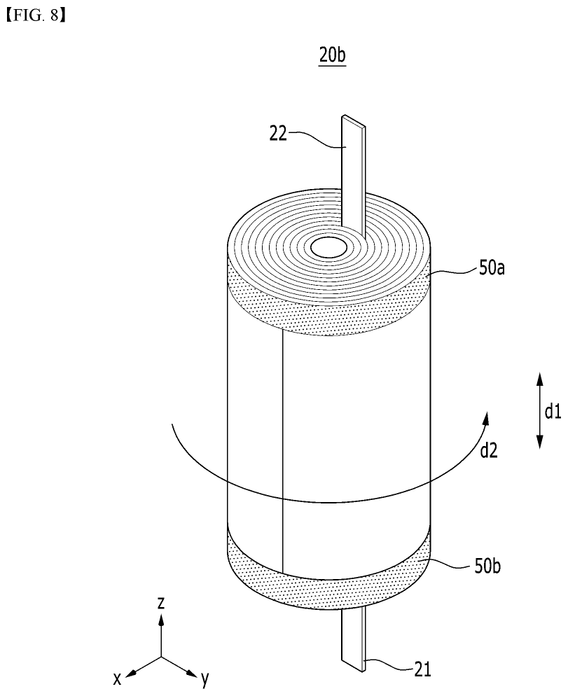

First, FIG. 8 is a perspective view of an electrode assembly to which two sealing tapes are attached according to a comparative example of the present disclosure.

Referring to FIG. 8, as a comparative example of the present disclosure, two sealing tapes attached to the outer peripheral surface of the electrode assembly 20b can be compared.

Specifically, the electrode assembly 20b according to the comparative example of the present disclosure is similar to Examples of the present disclosure in that the electrode current collector is exposed on the outer peripheral surface, but the difference is that two sealing tapes 50a and 50b are attached. The two sealing tapes 50a and 50b are spaced apart from each other along the height direction d1 of the electrode assembly 20b, and have a structure extending along the winding direction d2.

TABLE 1

| | | | Electrode assembly | | | AC resistance | |
|---|---|---|---|---|---|---|---|
| | Swelling tape | | Average | | Number | | ACIR |
| | | Attachment | outer | Average | of | | dispersion |
| | Thickness | length | diameter | circumference | winding | ACIR | (standard |
| | (μm) | (mm) | (mm) | (mm) | (time) | (mΩ) | deviation) |
| Example | 52 | 34 | 20.09 | 63.114 | 0.538 | 14.31 | 0.52 |
| 1 | | | | | | | |
| Example | 52 | 23 | 20.05 | 62.988 | 0.365 | 14.70 | 0.54 |
| 2 | | | | | | | |
| Example | 34 | 34 | 20.02 | 62.894 | 0.541 | 15.26 | 1.37 |
| 3 | | | | | | | |
| Example | 34 | 23 | 20.09 | 63.114 | 0.364 | 14.46 | 0.95 |
| 4 | | | | | | | |

Referring to Table 1, the secondary batteries including the electrode assembly to which the swelling tape was attached as shown in FIG. 6 were prepared as Examples 1 to 4. An experiment was conducted based on 30 samples for each Example, and AC resistance was measured.

In Table 1, the attachment length of the swelling tape is a value corresponding to the horizontal length R2 of the swelling tape 500 shown in FIG. 6. The outer diameter of the electrode assembly was measured for each sample of Examples 1 to 4 to derive the average outer diameter. The average circumference was calculated based on this. The average circumference is a value corresponding to the circumferential length R1 shown in FIG. 6. The number of windings is the value obtained by dividing the attachment length by the average circumference, which corresponds to the number of times the swelling tape according to the present embodiment wraps around the outer peripheral surface of the electrode assembly. The number of windings of Examples 1 to 4 is 0.3 times or more and 0.75 times or less.

TABLE 2

| | Sealing tape | Electrode assembly | | | AC resistance | |
|---|---|---|---|---|---|---|
| | 2-row | Average | | Number | | ACIR |
| | tape | outer | Average | of | | dispersion |
| | width | diameter | circumference | winding | ACIR | (standard |
| | (mm) | (mm) | (mm) | (times) | (mΩ) | deviation) |
| Comparative | 16 | 20.04 | 62.957 | 1 | 18.51 | 1.24 |
| Example 1 | | | | | | |
| Comparative | 9 | 20.05 | 62.988 | 1 | 18.80 | 0.80 |
| Example 2 | | | | | | |

Referring to Table 2, the secondary batteries including an electrode assembly to which two sealing tapes were attached as shown in FIG. 8 were prepared as Comparative Examples 1 and 2. An experiment was conducted based on 30 samples for each Comparative Example, and AC resistance was measured.

In Table 2, the tape width of the sealing tape is a value corresponding to the length in the height direction d1 with respect to the sealing tapes 50a and 50b shown in FIG. 8. Meanwhile, the number of windings can be seen to be one time as compared with the swelling tapes of Examples 1 to 4.

Referring to Tables 1 and 2, Examples 1 to 4 and Comparative Examples 1 and 2 have similar size specifications of the electrode assembly. However, it can be confirmed that in the case of Examples 1 to 4 to which the swelling tape wound by 0.3 times or more and 0.75 times or less was attached, all show an AC resistance near 15 mΩ, whereas in the case of Comparative Examples 1 and 2 to which two sealing tapes were attached, each of them shows high resistance of 18.51 mΩ and 18.80 mΩ.

TABLE 3

| | | | Electrode assembly | | | AC resistance | |
|---|---|---|---|---|---|---|---|
| | Swelling tape | | Average | | Number | | ACIR |
| | | Attachment | outer | Average | of | | dispersion |
| | Thickness | length | diameter | circumference | winding | ACIR | (standard |
| | (μm) | (mm) | (mm) | (mm) | (times) | (mΩ) | deviation) |
| Comparative | 52 | 50 | 20.11 | 63.177 | 0.791 | 17.12 | 1.24 |
| Example 3 | | | | | | | |
| Comparative | 34 | 50 | 20.03 | 62.926 | 0.794 | 17.75 | 2.23 |
| Example 4 | | | | | | | |

Referring to Table 3, the secondary batteries including the electrode assembly to which the swelling tape was attached as shown in FIG. 6 were prepared as Comparative Examples 3 and 4. An experiment was conducted based on 30 samples for each Example, and the AC resistance was measured.

In Table 3, the attachment length of the swelling tape is a value corresponding to the horizontal length R2 of the swelling tape 500 shown in FIG. 6. The outer diameter of the electrode assembly was measured for each sample of Comparative Examples 3 and 4 to derive the average outer diameter, and the average circumference was calculated based on this. The average circumference is a value corresponding to the circumferential length R1 shown in FIG. 6. The number of windings is a value obtained by dividing the attachment length by the average circumference, and corresponds to the number of times the swelling tape according to the present embodiment wraps around the outer circumferential surface of the electrode assembly. In Comparative Examples 3 and 4, the number of windings exceeds 0.75.

Referring to Table 1 and Table 3, it can be confirmed that all of Examples 1 to 4 wound by 0.3 times or more and 0.75 times or less show the AC resistance near 15 mΩ, whereas Comparative Examples 3 and 4 exceeding 0.75 times show high resistances of 17.12 mΩ and 17.75 mΩ, respectively. From this, it can be seen that due to the swelling tape having a length longer than necessary as described above, the area in which the exposed portion of the electrode assembly comes into contact with the inner wall of the battery case was reduced, so that the resistance was not effectively reduced.

Although the terms representing directions such as front, rear, left, right, upper and lower directions are used herein, it would be obvious to those skilled in the art that these merely represent for convenience of explanation, and may differ depending on a position of an observer, a position of an object, or the like.

A plurality of secondary batteries described above may be gathered to form a battery module. Specifically, the battery modules may be mounted together with various control and protection systems such as BDU (battery disconnect unit), BMS (battery management system) and a cooling system to form a battery pack.

The above-mentioned secondary battery, the batter module and the battery pack can be applied to various devices. Such a device can be applied to a vehicle means such as an electric bicycle, an electric vehicle, or a hybrid vehicle, but the present disclosure is not limited thereto, and is applicable to various devices that can use a secondary battery.

Although preferred embodiments of the present disclosure have been described in detail above, the scope of the present disclosure is not limited thereto, and various modifications and improvements made by those skilled in the art using the basic concepts of the present disclosure, which are defined in the appended claims, also belong to the scope of the present disclosure.

1. A secondary battery comprising:
a jelly roll type electrode assembly having a first electrode, a second electrode, and a separator, wherein the first electrode, the second electrode, and the separator are wound together;
a battery case receiving the electrode assembly therein; and
a swelling tape attached to an outer peripheral surface of the electrode assembly,
wherein the first electrode comprises a first electrode current collector and a first active material layer having an electrode active material on the first electrode current collector,
wherein the first electrode current collector comprises an exposed portion exposed at the outer peripheral surface of the electrode assembly, and
wherein the swelling tape causes the exposed portion to contact an inner wall of the battery case.

2. The secondary battery of claim 1, further comprises an electrolyte solution inside of the battery case,
wherein the swelling tape is expanded by absorbing the electrolyte solution.

3. The secondary battery of claim 1, wherein:
the swelling tape is asymmetrically attached to the outer peripheral surface of the electrode assembly with respect to a center of the electrode assembly.

4. The secondary battery of claim 1, wherein:
the swelling tape wraps the outer peripheral surface of the electrode assembly by 0.3 times or more of a circumference of the outer peripheral surface and 0.75 times or less of the circumference of the outer peripheral surface.

5. The secondary battery of claim 1, wherein:
the swelling tape extends along a height direction of the electrode assembly.

6. The secondary battery of claim 1, wherein:
the swelling tape covers an outermost edge part of the exposed portion.

7. The secondary battery of claim 1, wherein:
the first electrode is an anode, and
the first electrode current collector comprises at least one of copper, stainless steel, aluminum, or nickel.

8. The secondary battery of claim 1, wherein:
the battery case is a cylindrical case.

9. A device comprising the secondary battery as set forth in claim 1.

10. The secondary battery of claim 7, wherein:
the first electrode includes a first electrode tab extending along a height direction of the electrode assembly, the first electrode tab contacting the battery case.

11. The secondary battery of claim 10, further comprising a cap assembly located at an end of the battery case opposite an end where the first electrode tab contacts the battery case.
